(19) United States
(12) Patent Application Publication
(10) Pub. No.: US 2005/0128526 A1
(43) Pub. Date: Jun. 16, 2005

(54) Systems and methods for managing remote transmission receive destinations for a multi-connected fax or scanning device

(76) Inventors: Doug Kaltenecker, Meridian, ID (US); Kairi Johnston, Star, ID (US); Richard A. Burgin, Meridian, ID (US); Larry A. Copp, Boise, ID (US); Kram Henry Allen, Meridian, ID (US); Honee Lee Mesa, Eagle, ID (US); Jeffrey T. Aguilera, Nampa, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/734,981

(22) Filed: Dec. 12, 2003

(51) Int. Cl. H04N 1/00

(52) U.S. Cl. 358/400; 358/474

(57) ABSTRACT

Systems and methods are described herein for managing remote transmission destinations for a fax/scan device connected—directly or indirectly—to a network. When a fax/scan device is set to a “Receive Fax to PC” or “Scan-To PC” mode, a master host identifier that uniquely identifies a master host on the network is stored at the master host and at the fax/scan device. If another network computer attempts to supercede an existing master host for the fax/scan device, it is prevented from doing so because of the presence of the master host identifier in the fax/scan device. When the “Receive Fax to PC” or “Scan-To PC” mode is cleared, the master host identifier is also cleared. Only then may a network computer configure itself as a master host for the fax/scan device.

### TECHNICAL FIELD

The systems and methods described herein generally relate to fax machines and scanners. More particularly, the systems and methods described herein relate to managing remote transmission receive destinations for a fax device or scanner connected to more than one host PCs.

### BACKGROUND

Often, it is desirable to set a fax (facsimile) device to transmit a received fax to a remote location (i.e., a location somewhere other than the fax device itself). When this is done, the faxes may be retrieved in a more convenient location, or they may be examined before they are printed so that it is not necessary to print every fax received by the fax device. Also, some scanners may also be set to forward scanned images to a remote computer where it may be examined, manipulated and/or forwarded.

Some fax devices and scanners can be set to forward incoming faxes or scanned data to a computer host directly connected to the fax/scan device. The fax/scan devices may be set at the fax/scan device itself, or at the computer that hosts the fax/scan device. Providing this same feature when the fax/scan device is connected to more than one host computer, however, poses some problems. One example of connecting a fax/scan device to multiple host computers is by connecting everything to a network and accessing each other through that network. Another example is connecting two different host computers to the same fax/scan device through different direct connections, such as one through a Universal Serial Bus (USB) port and the other through a parallel connection. If more than one computer on the network have access to the fax/scan device, then it may be possible for each computer to act as a host computer for the fax/scan device by setting the computer as the host in fax/scan device software running on the computer. However, it can be problematic for other users to have different computers acting as hosts for the fax/scan device, since it may be hard or impossible to track where faxes or scanned images are being directed, or forwarded. Also, if one computer user is set up as the fax/scan device host, another computer may supercede the first computer as the fax/scan device host. As a result, a user of the first computer may expect faxes/scans to be forwarded to the first computer when, in actuality, they are being sent to the other computer.

### BRIEF DESCRIPTION OF THE DRAWINGS

The present invention is illustrated by way of example and not limitation in the figures of the accompanying drawings. The same numbers are used throughout the figures to reference like components and/or features.

FIG. 1 is a block diagram of a computing device and a fax/scan device set up in a network environment, according to an embodiment of the present invention.

FIG. 2 is a flow diagram of a methodological implementation of configuring a computer to be a master host for a fax/scan device, according to an embodiment of the present invention.

FIG. 3 is a flow diagram of a methodological implementation of configuring a fax/scan device to utilize a master host, according to an embodiment of the present invention.

FIG. 4 is flow diagram depicting a methodological implementation of receiving a fax/scan transmission when a fax/scan device has a master host identified for a ‘Receive to PC’ mode, according to an embodiment of the present invention.

### DETAILED DESCRIPTION

The following description sets forth one or more specific implementations and/or embodiments of systems and methods for managing remote transmission receive destinations for a network-connected fax/scan device. The applicants do not intend these exemplary implementations to limit the scope of the appended claims. Rather, the applicants have contemplated that the claimed systems and methods might also be embodied and implemented in other ways, in conjunction with other present or future technologies.

Computer-Executable Instructions

An implementation of one or more systems and/or methods for managing remote transmission receive destinations for a fax/scan device connected to more than one host computers may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Computer-Readable Media

For purposes of this document, the phrase “computer-readable media” may refer to any available media that can be accessed by a computer. By way of example, and not limitation, computer readable media may comprise “computer storage media” and “communications media.”

“Computer storage media” may include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile/video disks (DVD) or other optical storage devices, magnetic cassettes, magnetic tape, magnetic disk storage or other magnetic storage devices, or any other medium which can be used to store the desired information and which can be accessed by a computer.

“Communications media” typically embodies computer-readable instructions, data structures, program modules, or other data in a signal, such as carrier wave, the Public Internet or other transport mechanism. Communications media also includes any information delivery media.

Methods, systems, devices and computer-readable media, according to various implementations, relate to managing remote transmission receive destinations for a fax/scan device connected to more than one device. The systems and methods take into account that more than one computer may be able to set itself up as a master host to receive faxes or scans from a fax/scan device on a network (or through multiple direct connections), and provide a technique to prevent one computer from activating itself as a master host for the fax/scan device when another computer is already acting as a master host for the fax/scan device. The systems and methods allow for a master host to be configured from a host computer or the fax/scan device itself.

Any computer that stores software related to operating the fax/scan device may include a master host identifier generator that is configured to generate a master host identifier. The master host identifier is stored in the computer and is transmitted to and stored in memory of the fax/scan device. While the fax/scan device stores the master host identifier in its memory, faxes/scans received by the fax/scan device are transmitted to the master host identified by the master host identifier. As long as the fax/scan device stores the master host identifier, another computer cannot designate itself as a master host.

When the master host computer is removed as the master host for the fax/scan device (either at the computer itself or at the fax/scan device), then the master host identifier is removed from the fax/scan device memory. As long as no master host identifier is stored in the fax/scan device memory, a connected computer may designate itself a master host for the fax/scan device.

As used herein, a fax device means any electronic device that is capable of receiving fax transmissions and printing the received fax transmissions. Such devices include simple fax machines, all-in-one machines, faxes and scanners/copiers, and printers that can also perform fax reception functions. A printing mechanism of the fax device may be any type of printing mechanism known in the art, such as laser printing, ink jet printing, dry media printing, and the like.

Furthermore, as used herein, a scan device, or scanner, is a device configured to input a hardcopy image—such as a written document, a photograph, etc.—and convert the hardcopy image into an electronic image, or document, that can be transmitted, manipulated, viewed, etc. like any other type of electronic document.

Exemplary Operating Environment

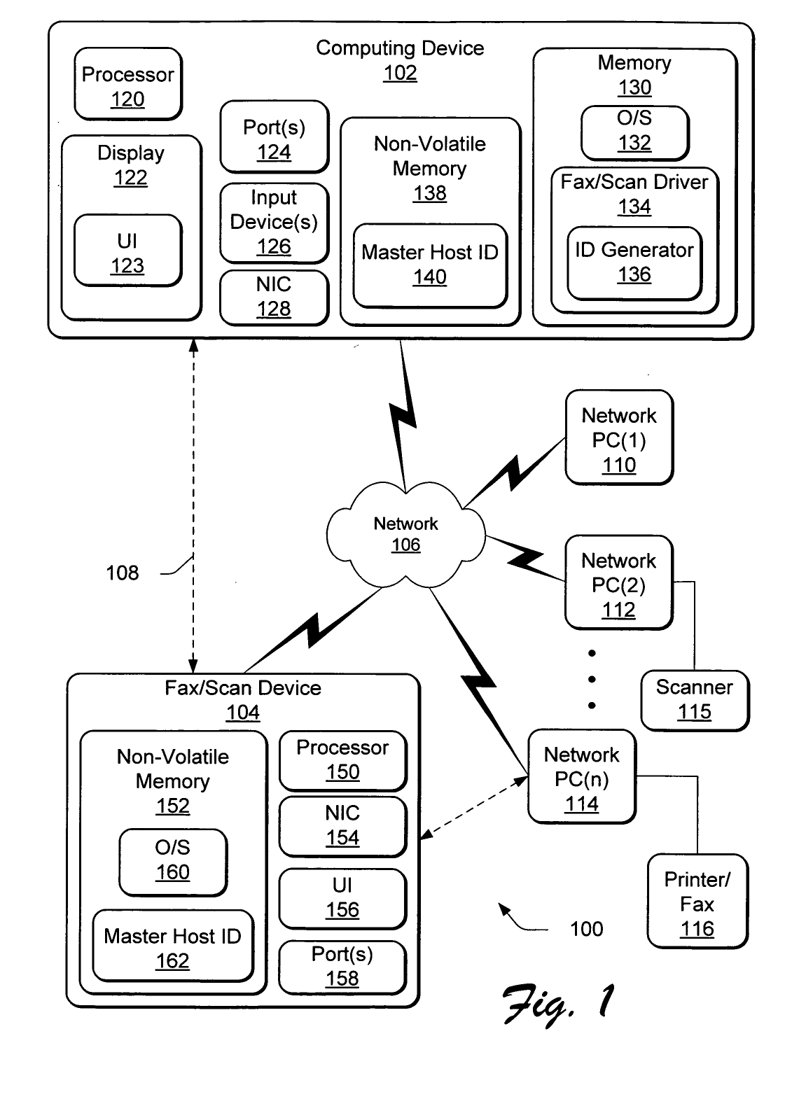

FIG. 1 is a block diagram of an exemplary operating environment 100 in which the claimed systems and methods may be implemented. The operating environment 100 includes an exemplary computing device 102, an exemplary fax/scan device 104, and a network 106. The fax/scan device 104 may be a fax device, a scan device or a combination of both, such as in a multi-function (“all-in-one”) machine that includes a printer, fax and scanner. The terms “fax,” “fax machine,” “scanner” or “scan device” may be used in lieu of the term “fax/scan device” when only a fax or a scanner is particularly referenced.

The computing device 102 communicates with the fax/scan device 104 directly via, for example, a serial port connection 108, or indirectly via the network 106. Other network personal computers—PC(1) 110, PC(2) 112 through PC(n) 114 may also be connected to the network 106. Peripheral devices, such as a scanner 115 or a printer/fax 116, may be connected to the network 106 or—as shown in FIG. 1—to another network personal computer, PC(1) 110-PC(n) 114.

In the following description, the exemplary computing device 102 and the exemplary fax/scan device 104 are shown having certain elements or features. It is noted that the elements shown are merely but a few of many elements that are included in the computing device 102 and the fax/scan device 104. Certain elements have been delineated for purposes of the discussion and the inclusion of these elements or exclusion of one or more other elements is exemplary only and is not intended to limit the scope of the appended claims in any way.

The exemplary computing device 102 includes a processor 120, a display 122, one or more communication ports 124, one or more input devices 126, and a network interface card (NIC) 128. The one or more communication ports may include, but are not limited to, a parallel port, a serial port, a USB port, an IEEE firewire port, and the like. The fax/scan device 104 may be directly connected to the computing device 102 through one of these ports.

The display 122 displays a user interface (UI) 123 through which a user receives and enters information. The input devices may include, but are not limited to, a keyboard, a mouse, a stylus, a touch-screen and the like. The network interface card 128 is used to connect the computing device 102 for communication with the network 106.

The computing device also includes memory 130 and non-volatile memory 138. Examples of memory components include, but are not limited to, random access memory (RAM), mass storage media, disk drives, and the like. Example of non-volatile memory include, but are not limited to, read-only memory (ROM), flash memory, EPROM, EEPROM, etc.. The memory 130 and the non-volatile memory 138, though shown as separate elements, may actually be only a single element (for example, non-volatile memory) that stores all the elements shown stored in the memory 130 and the non-volatile memory 138. However, for purposes of clarity, the non-volatile memory 138 is shown as a separate element that stores a master host identifier (ID) 140 in a persistent state. The memory 130, non-volatile memory 138 and the master host identifier 140 are discussed in greater detail below.

The memory 130 stores an operating system (O/S) 132 configured to control the operation of the computing device 102 and a fax/scan driver 134 that is configured to handle communications between the computing device 102 and the fax/scan device 104. The fax/scan driver 134 includes a master host identifier (ID) generator 136 that is configured to generate the master host identifier 140 that, when stored on the fax/scan device 104, causes faxed/scanned communications received by the fax/scan device 104 to be transmitted automatically to the computing device 102.

The fax/scan device 104 includes non-volatile memory 152, a processor 150, a network interface card (NIC) 154 that enables communication between the fax/scan device 104 and the network 106, and a user interface (UI) 156 through which a user may communicate with the fax/scan device 104. The user interface 156 may include a display (not shown) and a keypad (not shown) or any other method that enables communication with a user. The fax/scan device 104 also includes one or more communication ports 158 that are configured to enable communications between the fax/scan device 104 and other electronic devices, such as the computing device 102 (e.g., via a serial port).

The non-volatile memory 152 stores a fax/scan operating system (O/S) 160 that includes instructions that are processable on the processor 150 to control operations of the fax/scan device 104. The non-volatile memory 152 also stores a master host identifier (ID) 162 that, when present, identifies a host computer that is configured to receive faxes sent to or images scanned on the fax/scan device 104. There can either be one master host identifier 162 for both scan and fax jobs, or there can be two separate master host identifiers 162, one for each of a fax and a scanner. In at least one implementation, the master host identifier 162 may be set to zero, which indicates that there is no master host configured for the fax/scan device 104. This and other implementations will be discussed in greater detail below, with respect to the following figures.

Methodological Implementation: Configuring A Master Host

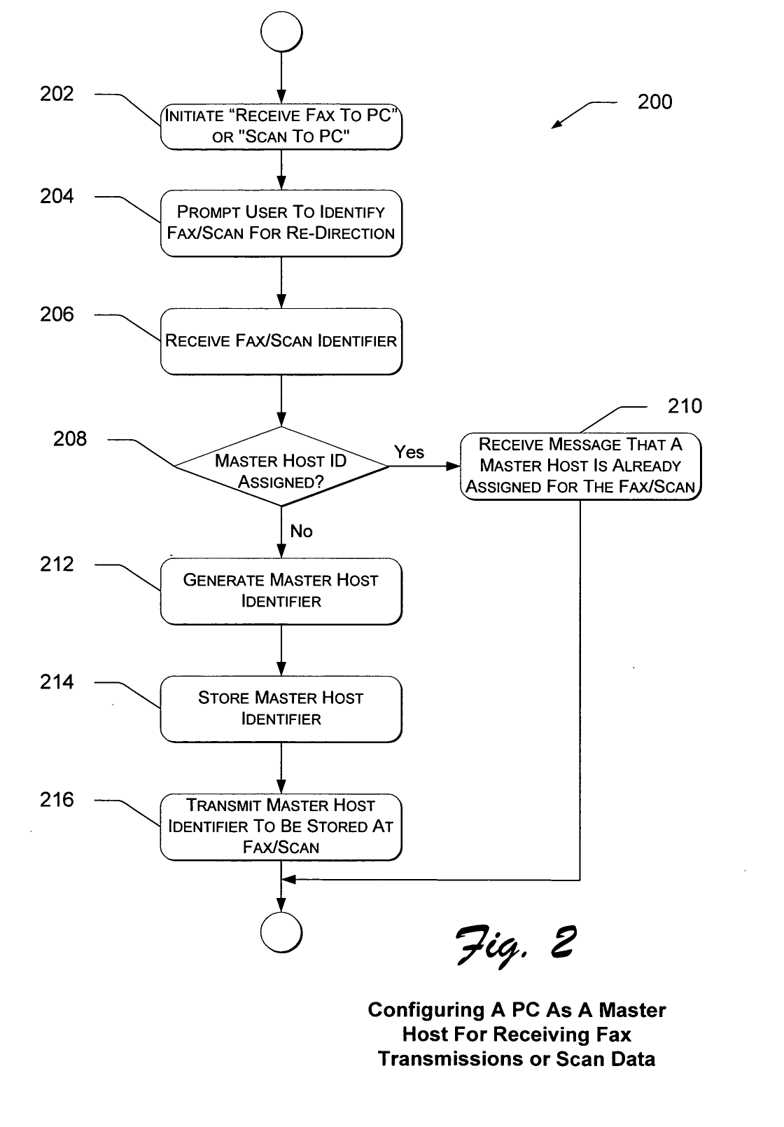

FIG. 2 is a flow diagram 200 depicting but one implementation of configuring a computing device to be a master host for receiving fax transmissions sent to a fax device or scanned documents from a scanner. In the following discussion, continuing reference will be made to the elements and reference numerals included in FIG. 1. It is noted that the steps outlined in FIG. 2 are discussed from the perspective of occurring on a network-connected computing device. However, it may be that one or more steps may be performed at a location or by an element other than the computing device. It may also occur on a device connected to multiple host computers via different direct connections such as a USB and parallel connections, rather than just through a network.

At step 202, a “Receive Fax to PC” or “Scan-To PC” function is initiated by a user at the computing device 102. The user interface 123 displays a prompt requesting the user to identify a fax/scanner to be configured for “Receive Fax to PC” or “Scan-To PC” (step 204). Typically, this may be done by displaying a list of fax/scan devices available through the computing device 102 and having the user select one of the available fax/scan devices. However, there are other ways in which this function may be implemented.

At step 206, the driver 134 receives a fax/scanner identifier from the user interface 123 that indicates the fax/scanner device to be re-directed. For this discussion, the fax/scan device 104 is the so-identified fax/scanner device. If a master host identifier 162 is assigned to the identified fax/scan device 104—i.e., if the master host identifier 162 is a non-zero value—(“Yes” branch, step 208), then, at step 210, the driver 134 provides a message via the user interface 123 that a master host is already assigned for the fax/scan device 104 and, therefore, the computing device 102 cannot alter the fax/scan device re-direction.

It is noted that there are several different ways in which step 208 may be implemented. In the reference above, when the “Receive Fax to PC” or “Scan-To PC” mode is removed or cleared, the master host identifier 162 is set to zero. This indicates that the fax/scan device 104 is not in the “Receive Fax to PC” or “Scan-To PC” mode. When configured in the “Receive Fax to PC” or “Scan-To PC” mode, the master host identifier 162 is set to a value—such as a value generated by the ID generator 136 or a network address and/or port ID—that uniquely identifies a master host on the network 106.

In another implementation, the mere presence of a master host identifier in the non-volatile memory 152 of the fax/scan device 104 indicates that the fax/scan device 104 is already in the “Receive Fax to PC” or “Scan-To PC” mode. If the master host identifier is not present, then a master host is not currently designated for the fax/scan device 104.

If a master host identifier 162 is not assigned to the fax/scan device 104 (“No” branch, step 208), then the ID generator 136 is invoked to generate a unique identifier (i.e. “master host id” 140) for the computing device 102 (step 212). This unique identifier may be based on a network address of the computing device 102 (and/or the port ID if not networked) or it may be composed of one or more other identifying features unique to the specific network 106.

The master host identifier 140, once generated, is stored in the non-volatile memory 138 at step 214. Storing the master host identifier 140 in non-volatile memory 138 insures that the master host identifier 140 is preserved in the event of a power loss at the computing device 102.

The master host identifier 140 is then transmitted to the fax/scan device 104, where it is stored in the non-volatile memory 152 of the fax/scan device 104 at step 216. Again, it is important that the master host identifier 162 be stored in non-volatile memory so that it is not unintentionally erased, wherein another network computer could then configure itself as a master host for the fax/scan device 104 without the knowledge or consent of the computing device 102.

As long as the master host identifier 162 remains in the non-volatile memory 152 of the fax/scan device 104, the fax/scan device 104 cannot be directed to re-direct received faxes or forward scanned data to any destination other than that designated by the master host identifier 162. When the fax/scan device 104 is taken out of “Receive Fax to PC” or “Scan-To PC” mode, the master host identifier 162 is reset to zero.

Methodological Implementation: Configuring A Fax/Scan Device

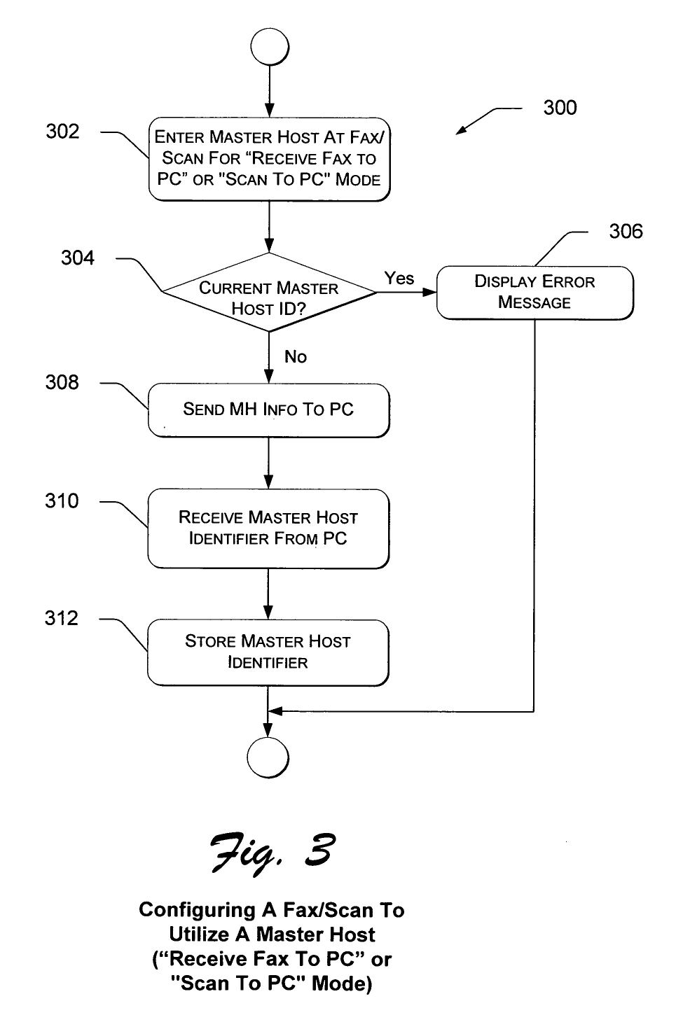

FIG. 3 is a flow diagram 300 depicting but one implementation of configuring a fax/scan device to utilize a master host, i.e., to configure a fax/scan device for “Receive Fax to PC” or “Scan-To PC” mode. In the following discussion, continuing reference will be made to the elements and reference numerals shown in FIG. 1. The steps outlined in FIG. 3 are performed at the fax/scan device 104. For discussion purposes, the master host identified in the fax/scan device 104 in the following example is the computing device 102 (FIG. 1).

At step 302, entries are made at the user interface 156 of the fax/scan device 104 to set the fax/scan device 104 in “Receive Fax to PC” or “Scan-To PC” mode and to identify a computing device 102 that is to receive future incoming faxes or scan data. When the information is entered into the fax/scan device 104, the operating system 160 of the fax/scan device 104 determines if the master host identifier 162 is set to a non-zero value (step 304).

If the master host identifier 162 is set to a non-zero value (“Yes” branch, step 304), it means that there is already a master host designated to receive faxes/scans sent to the fax/scan device 104. Therefore, a new master host may not be designated until the master host identifier 162 is cleared at the fax/scan device 104 or at the computing device designated as the master host. An error message is then displayed at step 306. The error message is displayed on the user interface 156 of the fax/scan device 104, and it may also be displayed on the computing device that serves as the current master host for the fax/scan device 104.

If there is not a current master host, i.e., if the master host identifier 162 is zero (“No” branch, step 304), then the master host information entered in step 302 is sent to the designated computing device 102 at step 308. The computing device 102 generates a master host identifier 140 and returns it to the fax/scan device 104, where it is received at step 310. The master host identifier 162 is stored in the non-volatile memory 152 of the fax/scan device 104 at step 312. Thereafter, all incoming faxes or scan data to the fax/scan device 104 will be re-directed to the computing device 102 until a command is entered at the computing device 102 or at the fax/scan device 104 to cancel the re-direction.

Methodological Implementation: Receiving Fax Transmissions or Scan Data

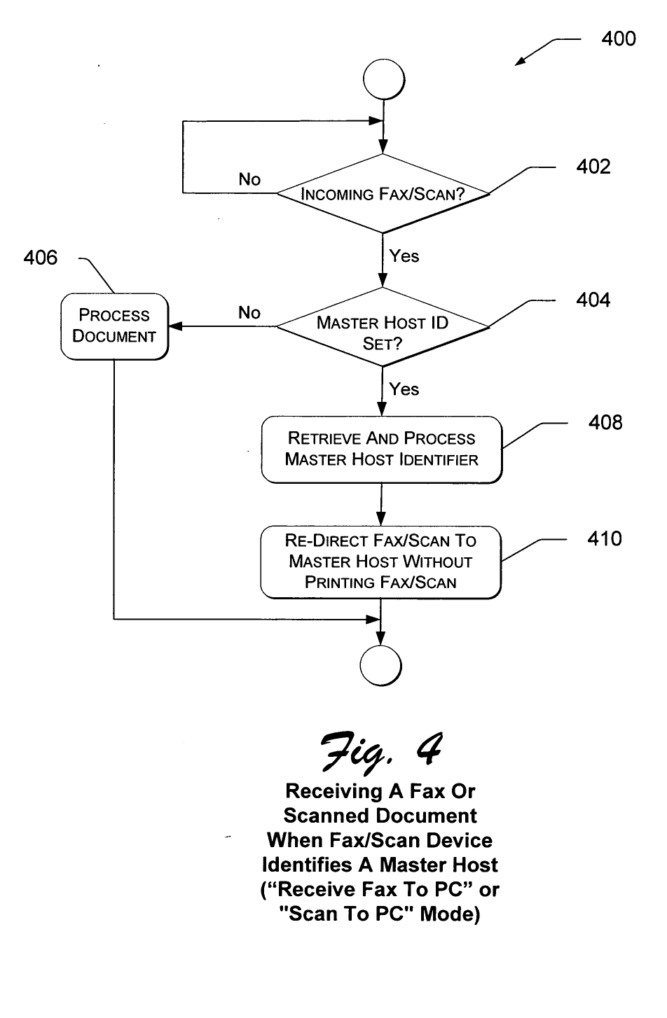

FIG. 4 is a flow diagram 400 depicting the process that occurs when a fax transmission is received or scan data is generated at the fax/scan device 104. In the following discussion, continuing reference will be made to the elements and reference numerals identified in FIG. 1.

The fax/scan device 104 monitors for an incoming fax or scan data at step 402. As long as no incoming fax or scan data is detected (“No” branch, step 402), then the process simply continues the monitoring. When an incoming fax or scan data is detected (“Yes” branch, step 402), the operating system 160 of the fax/scan device 104 determines if there is a master host identified, i.e., if the master host identifier 162 is a zero or a non-zero value (step 404). If a master host is not identified, i.e., the master host identifier is set to zero (“No” branch, step 404), then the data is processed as appropriate by the fax/scan device 104 at step 406. For instance, if it was a fax being received it may be printed, or if it was scan data, it may be aborted, as there is no host-computing device to receive any of the data.

If a master host is identified, i.e., the master host identifier is set to a non-zero value (“Yes” branch, step 404), then the master host identifier is retrieved at step 408 and is processed so that the incoming fax is re-directed or the scan data is sent to the identified master host (e.g., the host computer 102) at step 410.

The process reverts to step 402 after the incoming fax/scan has either been processed at step 406 or has been successfully re-directed at step 410.

Conclusion

Implementation of the systems and methods described herein provide ways for efficiently managing remote transmission receive destinations for a fax/scan device connected to more than one host computing device. Once a master host is set for the fax/scan device, the master host cannot be changed except at the master host or at the fax/scan device. As a result, other network computers cannot capriciously alter the master host designation.

Although the disclosed systems and methods have been described in language specific to structural features and/or methodological steps, it is to be understood that the systems and methods defined in the appended claims is not necessarily limited to the specific features or steps described. Rather, the specific features and steps are disclosed as preferred forms of implementing the claimed systems and methods.

1. A method, comprising:
receiving a command to set a fax/scan device to a “Receive Fax to PC” or “Scan-To PC” mode, wherein faxes sent or images scanned to the fax/scan device will be forwarded to a designated master host computing device;
determining if a master host computing device is currently designated for the fax/scan device;
if a master host computing device is currently designated for the fax/scan device, declining to set the fax/scan device to the “Receive Fax to PC” or “Scan-To PC” mode;
if a master host computing device is not currently designated for the fax/scan device, generating a master host identifier; and
transmitting the master host identifier to be stored on the fax/scan device, thereby setting the fax/scan device to the “Receive Fax to PC” or “Scan-To PC” mode.

2. The method as recited in claim 1, further comprising storing the master host identifier on the designated master host computing device.

3. The method as recited in claim 1, further comprising prompting a user to enter data identifying the fax/scan device.

4. The method as recited in claim 1, wherein the determining if a master host computing device has already been designated for the fax/scan device further comprises determining if a master host identifier is stored in memory of the fax/scan device and, if so, determining that a master host computing device has already been designated for the fax/scan device.

5. The method as recited in claim 1, wherein the determining if a master host computing device has already been designated for the fax/scan device further comprises determining if a master host identifier stored in memory of the fax/scan device represents a non-zero value and, if so, determining that a master host computing device has already been designated for the fax/scan device.

6. The method as recited in claim 1, wherein the generating a master host identifier further comprises generating a master host identifier that uniquely identifies the master host computing device to the fax/scan device.

7. The method as recited in claim 1, further comprising generating an error message that includes an indication that a master host computing device is already designated for the fax/scan device.

8. The method as recited in claim 1, wherein the fax/scan device further comprises a device selected from the following list: a fax machine; a multifunction device; a printer with fax capabilities; a scanner.

9. The method as recited in claim 1, wherein the fax/scan device and the master host computing device are connected to a network or multiple direct connections.

10. A method, comprising:
receiving a “Receive Fax to PC” or “Scan-To PC” instruction;
entering into a “Receive Fax to PC” or “Scan-To PC” mode;
receiving a master host identifier that uniquely identifies a master host computing device that will receive incoming faxes/scans while in “Receive Fax to PC” or “Scan-To PC” mode;
storing the master host identifier;
receiving a fax transmission or scan data; and
transmitting the fax transmission or scan data to the master host computing device.

11. The method as recited in claim 10, wherein the storing the master host identifier further comprises storing the master host identifier in non-volatile memory.

12. The method as recited in claim 10, wherein the receiving a “Receive Fax to PC” or “Scan-To PC” instruction further comprises receiving a “Receive Fax to PC” or “Scan-To PC” instruction from a fax/scan device user interface.

13. The method as recited in claim 10, wherein receiving a “Receive Fax to PC” or “Scan-To PC” instruction further comprises receiving a “Receive Fax to PC” or “Scan-To PC” instruction from a network computing device.

14. The method as recited in claim 10, wherein:
receiving a “Receive Fax to PC” or “Scan-To PC” instruction further comprises receiving a “Receive Fax to PC” or “Scan-To PC” instruction from a fax/scan device user interface;
the method further comprises the following additional steps:
receiving an identification of a computing device that is to be designated as the master host computing device; and
transmitting a request to the identified computing device to generate and return the master host identifier.

15. The method as recited in claim 10, further comprising:
receiving a request from a second computing device to enter “Receive Fax to PC” or “Scan-To PC” mode and designate the second computing device as the master host computing device; and
transmitting an error message to the second computing device indicating that the master host identifier is already set and cannot be changed by the second computing device.

16. A computing device, comprising:
a processor;
memory;
a fax/scan driver stored in the memory configured to communicate with a fax/scan device and set the fax/scan device to a “Receive Fax to PC” or “Scan-To PC” mode designating the computing device as a master host computing device, wherein faxes or scanned data received by the fax/scan device are transmitted to a master host computing device;
a master host identifier generator configured to uniquely identify the computing device that is the master host computing device; and
wherein the master host identifier is transmitted to the fax/scan device for storage therein, so that the computing device continues to be the master host computing device for the fax/scan device as long as the master host identifier is stored in the fax/scan device.

17. The computing device as recited in claim 16, further comprising non-volatile memory that stores the master host identifier.

18. The computing device as recited in claim 16, further comprising a user interface wherein a user enters data to configure the fax/scan device in the “Receive Fax to PC” or “Scan-To PC” mode and to designate the computing device as the master host computing device.

19. The computing device as recited in claim 16, further comprising one or more ports through which the computing device communicates with the fax/scan device.

20. The computing device as recited in claim 16, further comprising a network interface through which the computing device communicates with the fax/scan device via a network.

21. The computing device as recited in claim 16, wherein the fax/scan driver is further configured to remove the master host computing device designation and take the fax/scan device out of “Receive Fax to PC” or “Scan-To PC” mode.

22. A fax/scan device, comprising:
a processor;
a non-volatile memory;
means for communicating with a network computing device;
a master host identifier stored in the non-volatile memory; and
an operating system configured to detect incoming fax transmissions/scanned data and to transmit the incoming fax transmissions/scanned data to a master host computing device identified by the master host identifier when the fax/scan device is in a “Receive Fax to PC” or “Scan-To PC” mode.

23. The fax/scan device as recited in claim 22, wherein the means for communicating with a network computing device further comprises one or more ports through which the fax/scan device may directly communicate with the network computing device.

24. The fax/scan device as recited in claim 22, wherein the means for communicating with a network computing device further comprises a network interface through which the fax/scan device may indirectly communicate with the network computing device via a network.

25. The fax/scan device as recited in claim 22, further comprising a user interface that may be used to set the fax/scan device to “Receive Fax to PC” or “Scan-To PC” mode.

26. The fax/scan device as recited in claim 22, wherein the operating system is further configured to generate and transmit an error message to a computing device other than the master host when that computing device attempts to designate a new master host when the fax/scan device is in “Receive Fax to PC” or “Scan-To PC” mode.

27. One or more computer-readable media containing computer-executable instructions that, when executed on a computer, perform the following steps:
determining if a fax/scan device is set to a “Receive Fax to PC” or “Scan-To PC” mode;
if the fax/scan device is not set to the “Receive Fax to PC” or “Scan-To PC” mode, generating a master host identifier that uniquely identifies a master host computing device for the fax/scan device that receive fax transmissions sent to the fax device or scanned images from the fax/scan device;
storing the master host identifier at the fax/scan device so that fax transmissions/image data received by the fax/scan device will be transmitted to the master host computing device; and
wherein the master host identifier can only be altered by the fax/scan device or by the master host computing device.

28. The one or more computer-readable media as recited in claim 27, further comprising the step of receiving a request to set the fax/scan device to the “Receive Fax to PC” or “Scan-To PC” mode.

29. The one or more computer-readable media as recited in claim 27, wherein the determining step further comprises:
reading at least a portion of fax/scan device memory to determine if the fax/scan device memory stores a master host identifier; and
if the fax/scan device memory stores a master host identifier, determining that the fax/scan device is set to “Receive Fax to PC” or “Scan-To PC” mode.

30. The one or more computer-readable media instructions as recited in claim 27, wherein the determining step further comprises:
reading a value of a master host identifier stored in fax/scan device memory; and
if the master host identifier identifies a non-zero value, determining that the fax/scan device is set to “Receive Fax to PC” or “Scan-To PC” mode.

31. The one or more computer-readable media instructions as recited in claim 27, further comprising disabling “Receive Fax to PC” or “Scan-To PC” mode on the fax/scan device by transmitting an instruction to the fax/scan device to clear the master host identifier from fax/scan device memory.
